(19) United States
(12) Patent Application Publication
(10) Pub. No.: US 2026/0142535 A1
(43) Pub. Date: May 21, 2026

(54) MOTOR

(71) Applicant: HYUNDAI WIA Corporation, Changwon-si (KR)

(72) Inventors: Keon Sik Lee, Uiwang-si (KR); Sang Min Lee, Uiwang-si (KR); Hyun Jun Seo, Uiwang-si (KR); Ji Sub Shin, Uiwang-si (KR)

(21) Appl. No.: 19/386,924

(22) Filed: Nov. 12, 2025

(30) Foreign Application Priority Data
Nov. 19, 2024 (KR) 10-2024-0165574
Jul. 14, 2025 (KR) 10-2025-0094678

(51) Int. Cl. H02K 11/01; H02K 5/22; H02K 7/00; H02K 11/40

(52) U.S. Cl. CPC H02K 11/0141; H02K 5/225; H02K 7/003; H02K 11/40

(57) ABSTRACT

A motor comprises a housing of a polymer material; a stator provided at an inside of the housing; a shielding cover inserted at one side of the housing and overmolded, wherein the shielding cover is configured to shield electromagnetic waves; and a power supply pin and a ground pin, each of which penetrates the shielding cover and comprises a first end connected to the stator, and a second end exposed to one side of the housing.

### CROSS-REFERENCE TO THE RELATED APPLICATION

This application claims priority from Korean Patent Applications No. 10-2024-0165574 filed on Nov. 19, 2024 and No. 10-2025-0094678 filed on Jul. 14, 2025, in the Korean Intellectual Property Office, the disclosures of which are incorporated herein by reference in their entireties.

### BACKGROUND OF THE DISCLOSURE

### 1. Field of the disclosure

The present disclosure relates to a motor.

### 2. Description of the Related Art

A motor is a device configured with a stator and a rotor, and is used as a configuration of various machines. Meanwhile, a motor generates electromagnetic interference during operation and can interfere with surrounding electronic equipment (sensors, communication devices, etc.). Accordingly, a shielding cover for EMC (Electromagnetic Compatibility) can be provided at the motor.

### SUMMARY OF THE DISCLOSURE

Meanwhile, a shielding cover for blocking electromagnetic waves is attached to an outside of a housing, and when using a shielding cover of a metal material, corrosion due to an external environment can occur at an outside of the shielding cover, and noise is generated as the shielding cover also vibrates due to vibration generated during operation of the motor.

The present disclosure is intended to provide a motor capable of solving the above-described problems by inserting a shielding cover at an inside of a housing and then molding.

A motor according to the present disclosure comprises a housing of a polymer material, wherein a stator is provided at an inside of the housing; a shielding cover inserted at one side of the housing and overmolded, wherein the shielding cover is configured to shield electromagnetic waves; and a power supply pin and a ground pin, wherein first end is connected to the stator, and second end penetrates the shielding cover and is exposed to one side of the housing.

According to one embodiment, the stator is overmolded at an inside of the housing.

According to one embodiment, a connector is formed at the housing, the power supply pin and the ground pin connected to the stator being extended and exposed to one side of the housing through the connector, and first end of the power supply pin and the ground pin is connected to the stator, and second end penetrates the shielding cover and can be disposed at an inside of the connector.

According to one embodiment, the power supply pin can be disposed at an inside of the connector by penetrating the shielding cover in a state of non-contact with the shielding cover.

According to one embodiment, the shielding cover is of a metal material, and the ground pin can be disposed at an inside of the connector by penetrating the shielding cover in a state of contact with the shielding cover.

According to one embodiment, the power supply pin is connected to a winding at an inside of the stator and is configured to supply power to the stator, and the ground pin can be connected to an outside of the stator and can be configured to ground the stator.

According to one embodiment, the shielding cover is of a metal material, and the ground pin can penetrate the shielding cover in a state of contact with the shielding cover and can be configured to simultaneously ground the stator and the shielding cover.

According to one embodiment, the shielding cover can comprise a stator shielding part configured to shield electromagnetic waves generated from the stator; and a connector shielding part extended to a side part of the connector and configured to shield electromagnetic waves generated in the connector.

According to one embodiment, first end of the power supply pin can be connected to the stator, and first end of the ground pin can be connected to the connector shielding part.

According to one embodiment, a ground line can be connected to an end part of the shielding cover spaced apart from the connector shielding part.

According to one embodiment, first end of the ground line can be connected to an end part of the shielding cover through bolting.

According to one embodiment, first end of the ground pin can be connected to an outside of the stator, and second end can penetrate the shielding cover in a state of non-contact with the shielding cover.

According to one embodiment, a rotor provided with a rotating shaft is provided at an inside of the housing, an impeller is provided at first end of the rotating shaft, and second end can be supported by a spherical ball provided at an inside of the housing.

According to one embodiment, a rotor provided with a rotating shaft is provided at an inside of the housing, a rotating shaft support part is formed at a central end part of the shielding cover, an impeller is provided at first end of the rotating shaft, and second end can be supported by the rotating shaft support part at an inside of the housing.

A motor according to the present disclosure inserts a shielding cover for blocking electromagnetic waves generated from a stator or the like during operation of the motor at a housing and overmolds, so that corrosion of the shielding cover due to external environment changes is prevented, and it is possible to suppress generation of noise and vibration due to vibration of the shielding cover as vibration generated during operation of the motor acts on the shielding cover.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a vertical cross-sectional view of a pump to which a motor according to a first embodiment of the present disclosure is applied;

FIG. 2 illustrates a connector formed at an end part of a housing;

FIG. 3 illustrates a cross-section of a state before a shielding cover, a power supply pin, and a ground pin are overmolded;

FIG. 4 illustrates a cross-section of a state after a shielding cover, a power supply pin, and a ground pin are overmolded;

FIG. 5 is a vertical cross-sectional view of a pump to which a motor according to a second embodiment of the present disclosure is applied;

FIG. 6 is a vertical cross-sectional view of a pump to which a motor according to a third embodiment of the present disclosure is applied;

FIG. 7 is a vertical cross-sectional view of a pump to which a motor according to a fourth embodiment of the present disclosure is applied; and

FIG. 8 is a vertical cross-sectional view of a pump to which a motor according to a fifth embodiment of the present disclosure is applied.

### DETAILED DESCRIPTION OF EMBODIMENTS

In describing the embodiments disclosed in the present specification, when it is determined that a specific description of related known technologies may obscure the gist of the embodiments disclosed in the present specification, the detailed description thereof will be omitted. In addition, the accompanying drawings are only for easily understanding the embodiments disclosed in the present specification, and the technical idea disclosed in the present specification is not limited by the accompanying drawings, and should be understood to include all changes, equivalents, and substitutes included in the spirit and technical scope of the present disclosure. The disclosure hereinafter is not intended to limit the present disclosure to the form described or to a specific field, and it is considered that various alternative aspects and modifications to the present disclosure are possible, whether explicitly described or implied in the present specification. Those skilled in the art to which the present disclosure pertains will recognize that the form and details of the present disclosure may be changed.

The present disclosure is described with reference to specific aspects. However, as those skilled in the art to which the present disclosure pertains understand, the various aspects disclosed in the present specification can be modified in various other ways or implemented differently without departing from the spirit and scope of the present disclosure. Therefore, the following description should be considered as illustrative and is for the purpose of teaching those skilled in the art to which the present disclosure pertains how to make and use the various embodiments. It will be understood that the forms of the disclosure shown and described in the present specification will be taken as representative embodiments. Equivalent elements, or materials, processes or steps can be substituted for those representatively illustrated and described in the present disclosure. Expressions such as “including”, “comprising”, “incorporating”, “consisting of”, “have”, “is”, etc. used in describing the present disclosure should be interpreted in a non-exclusive manner, that is, to allow items, components or elements not explicitly described to be displayed. In addition, references to the singular should be interpreted to include those related to the plural.

In addition, the various embodiments disclosed in the present specification should be taken in an illustrative and descriptive sense and should not be construed as limiting the content of the present disclosure. All references to joining (for example, attached, affixed, coupled, connected, etc.) are used only to aid in understanding the present disclosure, and are not intended to limit the location, direction or use of the configuration or the method disclosed in the present specification. Therefore, if there are joining references, this should be interpreted broadly. Moreover, in these joining references, it is not concluded that two or more elements are directly connected to each other. Additionally, all numerical terms, for example, “first”, “second”, “third”, “primary”, “secondary”, “main” or any other general term or numerical term, should be taken only as identifiers to assist in understanding the various components, forms, changes or modifications of the present disclosure, and do not mean limitations to any component, form, change or modification or the order or preference thereof. That is, these expressions can be used to describe various components, but the components are not limited by these expressions. These expressions are used only for the purpose of distinguishing one component from another component.

The suffixes “module” and “part” for components used in the following description are given or used interchangeably considering only the ease of writing the specification, and do not have meanings or roles that are distinguished from each other in themselves.

When a component is referred to as being “connected” or “contacted” to another component, it should be understood that it may be directly connected or contacted to the other component, but other components may exist in between. On the other hand, when a component is referred to as being “directly connected” or “directly contacted” to another component, it should be understood that there are no other components in between.

Any number of components or various components in any of the configurations described in the present specification can be included within the disclosure described in the present specification. Components can include any combination of features described in the present specification and can be arranged in any of the various configurations described in the present specification. The concepts regarding the structure and arrangement of the components of the present disclosure as well as their use and operation can be applied to the specific embodiments discussed in the present specification as well as any number of embodiments in any combination. Embodiments including those having various features of various arrangements are described below with reference to the drawings.

Hereinafter, various embodiments disclosed in the present specification will be described in detail with reference to the accompanying drawings, and the same or similar components will be given the same reference numbers regardless of drawing symbols, and redundant descriptions thereof will be omitted.

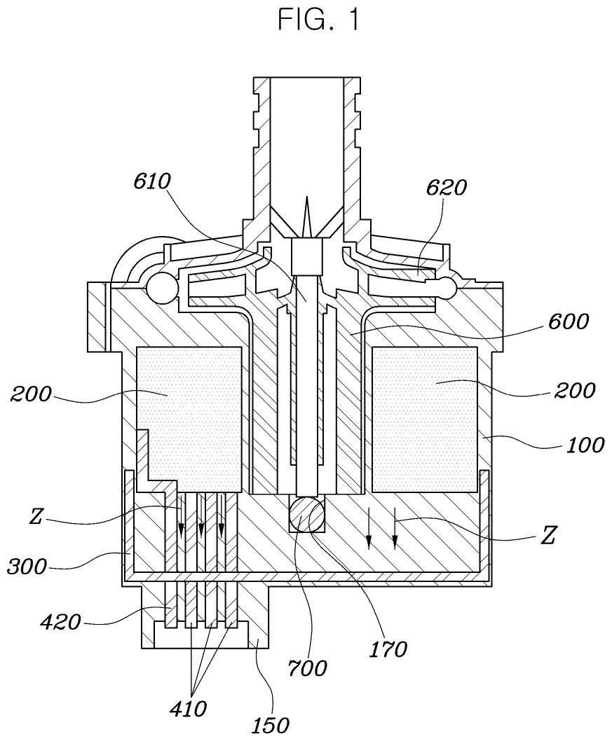

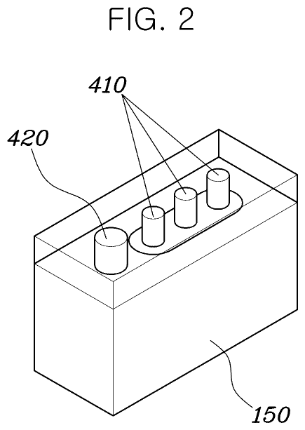

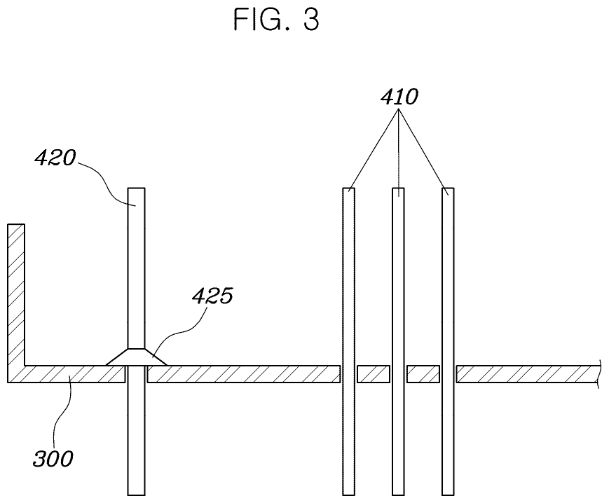

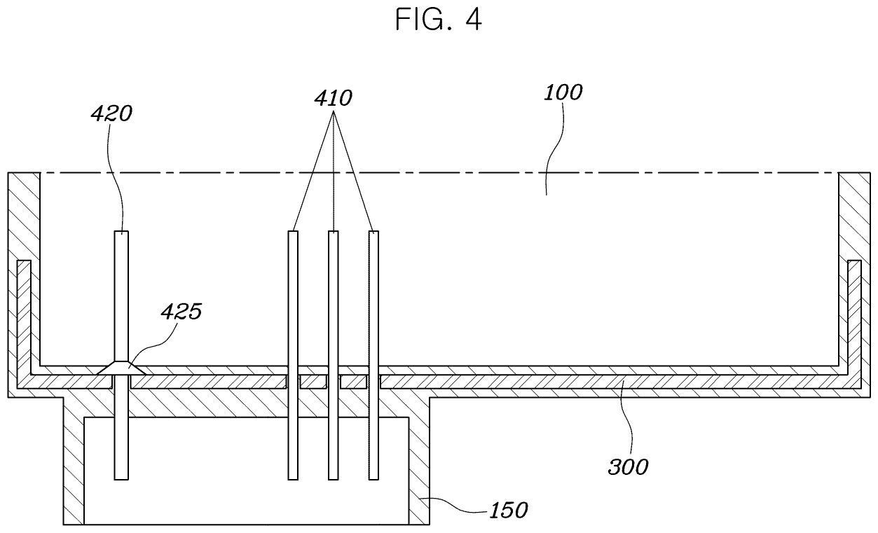

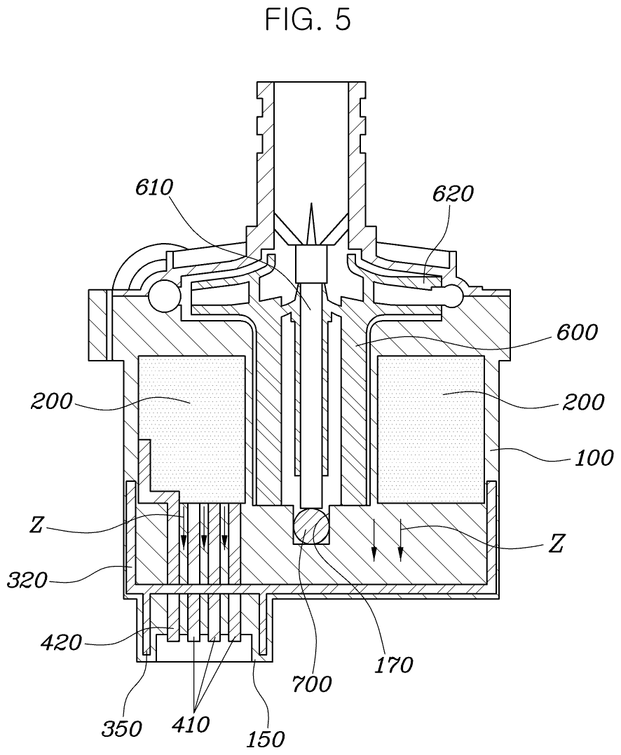

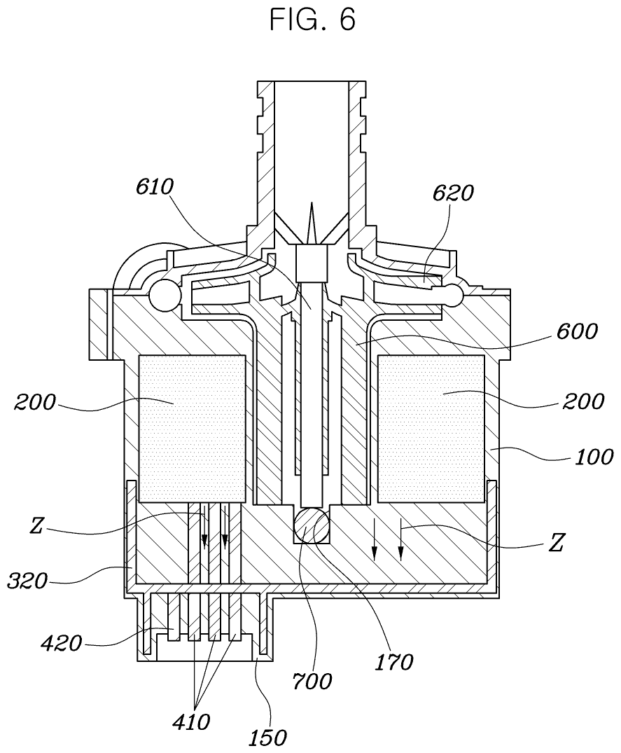

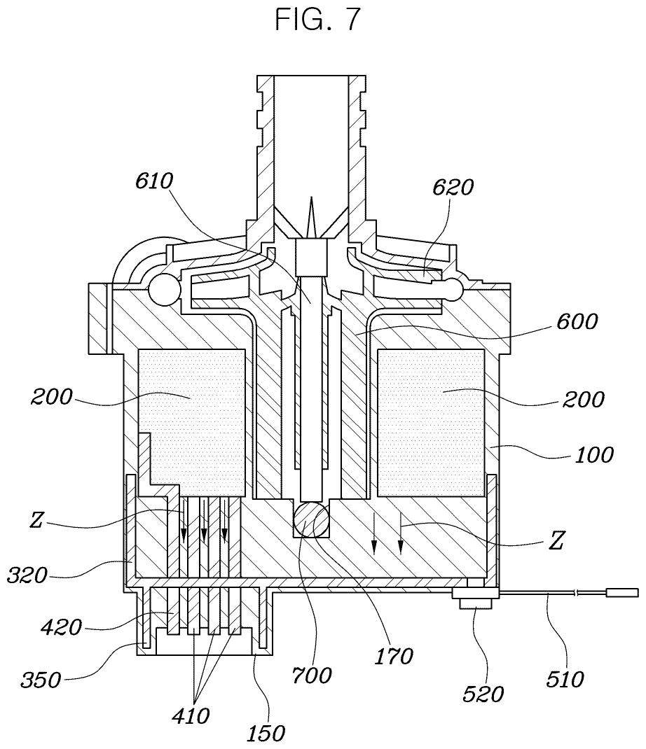

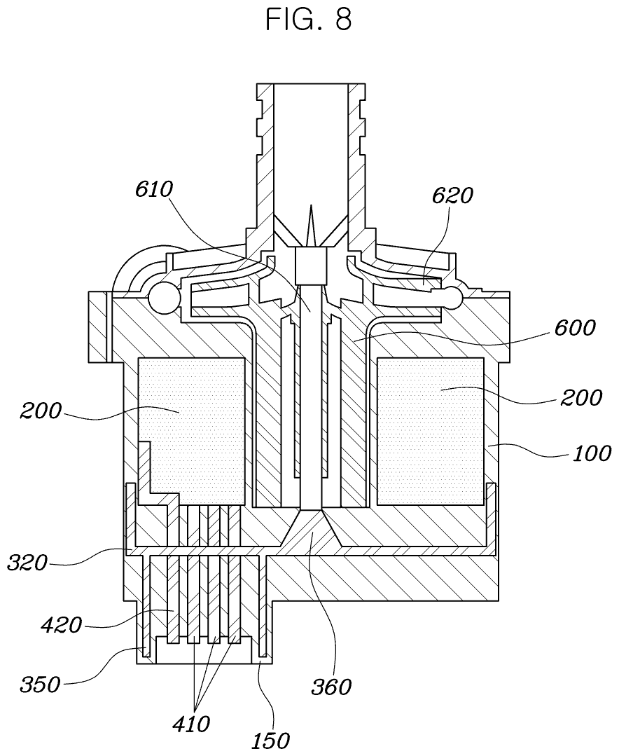

FIG. 1 illustrates a vertical cross-sectional view of a pump to which a motor according to a first embodiment of the present disclosure is applied. FIG. 2 illustrates a connector formed at an end part of a housing. FIG. 3 illustrates a cross-section of a state before a shielding cover, a power supply pin, and a ground pin are overmolded. FIG. 4 illustrates a cross-section of a state after a shielding cover, a power supply pin, and a ground pin are overmolded. FIG. 5 illustrates a vertical cross-sectional view of a pump to which a motor according to a second embodiment of the present disclosure is applied. FIG. 6 illustrates a vertical cross-sectional view of a pump to which a motor according to a third embodiment of the present disclosure is applied. FIG. 7 illustrates a vertical cross-sectional view of a pump to which a motor according to a fourth embodiment of the present disclosure is applied. FIG. 8 illustrates a vertical cross-sectional view of a pump to which a motor according to a fifth embodiment of the present disclosure is applied.

A motor according to the present disclosure will be described with reference to FIGS. 1 to 8. The motor according to the present disclosure can be a motor used in a pump connected to impeller 620 and configured to pressurize an inflowing liquid.

Referring to FIG. 1, the motor according to the present disclosure can be configured with stator 200 and rotor 600. Stator 200 and rotor 600 are disposed at an inside of housing 100. Housing 100 is made of a nonmagnetic, nonconductive material, and can be molded with a polymer material such as plastic.

Stator 200 comprises a stator core and a plurality of windings wound on the stator core. And the stator core and the plurality of windings are disposed in a stator frame forming an external form of the stator. Stator 200 has a ring shape, and a space in which rotor 600 is accommodated is formed at an inside. The stator frame can be manufactured with a metal material for reasons of mechanical rigidity, durability, and cooling, and stator 200 can be overmolded to housing 100 and integrated with housing 100. By overmolding stator 200 to the housing, there are advantages that the number of parts is reduced, assembly of stator 200 is simplified, and weight reduction of the motor is possible.

In addition, housing 100 and stator 200 are integrated, so that vibration and noise due to motor operation can be suppressed.

Rotor 600 can comprise a rotor core and a permanent magnet fixed to the rotor core. And, rotating shaft 610 is disposed at an inside of rotor 600, and a configuration such as impeller 620 can be coupled to rotating shaft 610.

When power is supplied to stator 200, rotor 600 rotates, and rotating shaft 610 at an inside of rotor 600 can rotate together to drive impeller 620. More specifically, when three-phase voltages converted through a power conversion device (inverter) are applied at a constant cycle to a plurality of windings wound on the stator core disposed at an inside of stator 200, rotor 600 can be rotated.

In this way, when the motor is driven, a large amount of electromagnetic waves are generated from the plurality of windings at an inside of stator 200, and the large amount of electromagnetic waves are radiated (Z) from an inside of housing 100 to an outside of the housing. The large amount of electromagnetic waves radiated (Z) to an outside of housing 100 can interfere with surrounding electronic equipment (sensors, communication devices, etc.), and malfunctions of surrounding equipment can occur. Therefore, to prevent malfunctions of surrounding electronic devices, the motor comprises shielding cover 300 configured to shield electromagnetic waves.

According to the present disclosure, shielding cover 300 can be overmolded to housing 100 and integrally formed with housing 100. That is, shielding cover 300 can be inserted into a mold for molding the housing, and housing 100 can be molded to enclose all of shielding cover 300.

Here, shielding cover 300 can be manufactured with a metal material for efficient electromagnetic wave shielding. The reason for manufacturing shielding cover 300 with a metal material is because of conductivity and magnetic properties capable of reflecting and absorbing electromagnetic waves. For example, shielding cover 300 can be manufactured with aluminum or an alloy material including aluminum.

When housing 100 is manufactured by overmolding shielding cover 300, shielding cover 300 is completely enclosed by housing 100, so that air or moisture contact is reduced and corrosion is prevented, and because the polymer resin tightly encloses the shielding cover in the process of molding housing 100, it is completely integrated with housing 100, and vibration and noise due to motor operation can be absorbed and distributed, so that NVH performance can be improved.

Meanwhile, a ground pin 420 configured to prevent current at an inside of the stator core or stator frame at an inside of stator 200 from leaking to the outside and a power supply pin 410 configured to apply power to the plurality of windings wound on the stator core are both connected to stator 200.

Specifically, power supply pin 410 can be provided with a plurality of power supply pins to apply three-phase voltages to the plurality of windings. The plurality of windings are directly connected to power supply pin 410, and can receive power supplied by the power conversion device through power supply pin 410 to rotate rotor 600.

Ground pin 420 is coupled to an outside of stator 200, that is, to the stator frame, and can ground current leaking from stator 200.

Referring to FIGS. 1 and 2, both power supply pin 410 and ground pin 420 have first end connected to stator 200, and both have second end penetrating shielding cover 300. At an end part of housing 100, connector 150 can be formed in which second end of power supply pin 410 and second end of ground pin 420 penetrating shielding cover 300 are extended and exposed to one side of housing 100.

And, ground pin 420 and power supply pin 410 disposed at an inside of connector 150 are connected to an external connector drawn from the power conversion device, so that ground pin 420 can be connected to a ground bus bar of the power conversion device, and power supply pin 410 can be connected to a power bus bar of the power conversion device.

At this time, power supply pin 410 is disposed at an inside of connector 150 by penetrating shielding cover 300 in a state of non-contact with shielding cover 300. On the other hand, ground pin 420 can be disposed at an inside of connector 150 by penetrating shielding cover 300 in a state of contact with shielding cover 300. First end of ground pin 420 is connected to stator 200, and an extended end part contacts shielding cover 300, so that grounding of stator 200 as well as grounding of shielding cover 300 can be simultaneously performed.

Shielding cover 300 needs grounding to shield electromagnetic waves generated from stator 200. Electromagnetic waves generated from stator 200 are flowed to the outside through ground pin 420, or some float inside the housing and are absorbed by shielding cover 300. Therefore, electromagnetic waves absorbed by shielding cover 300 can be flowed to the outside through ground pin 420 in contact with shielding cover 300.

On the other hand, for power supply pin 410, if electromagnetic waves absorbed by shielding cover 300 flow into power supply pin 410 in reverse, noise interference can occur. Thus, in embodiments, power supply pin 410 penetrates shielding cover 300 in a state of non-contact with shielding cover 300.

Referring to FIG. 3, before housing 100 is molded, shielding cover 300, stator 200, power supply pin 410, and ground pin 420 can be disposed as illustrated. Ground pin 420 is in close contact with shielding cover 300, and both ground pin 420 and shielding cover 300 are of a metal material having conductivity, so that ground pin 420—shielding cover 300 can be electrically connected.

Specifically, contact part 425 having a diameter longer than a hole formed in shielding cover 300 is formed at ground pin 420, so that contact part 425 is in close contact with an end part around the hole formed in shielding cover 300.

And, power supply pin 410 is disposed to penetrate shielding cover 300 in a state of non-contact with shielding cover 300.

In the state as in FIG. 3, when housing 100 is molded by injecting polymer resin into a mold, as in FIG. 4, shielding cover 300, ground pin 420, and power supply pin 410 are all enclosed by the polymer resin configuring housing 100. A position of a part of ground pin 420 is fixed by the filled polymer resin, and electrical connection between ground pin 420 and shielding cover 300 is maintained by the polymer resin. And, polymer resin is also filled between power supply pin 410 and shielding cover 300, so that a state in which power supply pin 410 penetrates shielding cover 300 in a state of non-contact with shielding cover 300 can be maintained.

Meanwhile, referring to FIG. 5, according to the second embodiment, shielding cover 300 can comprise stator shielding part 320 configured to shield electromagnetic waves generated from stator 200 and connector shielding part 350 extended to a side part of connector 150 and configured to shield electromagnetic waves generated in connector 150.

Both stator shielding part 320 and connector shielding part 350 are overmolded at an inside of housing 100, and as in the first embodiment, ground pin 420 maintains a state of contact with shielding cover 300. Because there is a possibility that electromagnetic waves are also generated at an inside of connector 150 of housing 100, shielding cover 300 can be further extended to enable electromagnetic wave shielding up to a part where connector 150 is formed.

At this time, electromagnetic waves at an inside of connector 150 can flow to the outside through ground pin 420 at an inside of connector 150, so that electromagnetic waves at an inside of connector 150 can be removed.

Referring to FIG. 6, according to the third embodiment, first end of ground pin 420 can be connected not to the stator but to connector shielding part 350. Electromagnetic waves generated from stator 200 are radiated (Z) from an inside of the housing to an outside, so they are absorbed by shielding cover 300, and electromagnetic waves in the housing can be removed through ground pin 420 electrically connected to shielding cover 300.

According to the first embodiment or the second embodiment, polymer resin is filled between ground pin 420 and connector 150, but there is a possibility that external moisture can flow into an inside of housing 100 along an interface between ground pin 420 and connector 150.

The third embodiment changes a structure in which ground pin 420 penetrates shielding cover 300, and connects ground pin 420 itself to shielding cover 300, removing the hole formed in shielding cover 300, so that the possibility that external moisture can flow into an inside of housing 100 can be excluded.

For implementation of the third embodiment, it is desirable to weld ground pin 420 itself to shielding cover 300, and then insert shielding cover 300 into a mold and mold housing 100.

Referring to FIG. 7, according to the fourth embodiment, a separate ground line 510 can be connected to an end part of shielding cover 300. Ground line 510 can be connected to an end part of shielding cover 300 spaced apart from connector shielding part 350 of shielding cover 300. Ground line 510 is configured for grounding of shielding cover 300 and performs the same role as ground pin 420. That is, first end of ground line 510 is connected to an end part of shielding cover 300 through bolting 520, and second end is connected to a structure other than the motor to flow electromagnetic waves in housing 100 to the outside.

In the first to third embodiments, there is one point for shielding electromagnetic waves, so that electromagnetic waves are concentrated to that point and heat generation can occur. Therefore, to address the foregoing, a separate ground line 510 is formed in the fourth embodiment.

Separately formed ground line 510 distributes routes through which electromagnetic waves in housing 100 are released to the outside, so that electromagnetic waves in the housing can be stably removed. In addition, separate ground line 510 can be a backup route through which electromagnetic waves in housing 100 can be released even if poor contact of ground pin 420 occurs.

For stable distribution and removal of electromagnetic waves, in embodiments, a spaced distance between ground pin 420 and ground line 510 is sufficiently secured.

Referring to FIG. 7, as in the first to second embodiments, it is possible to allow ground pin 420 to contact shielding cover 300, but it is also possible for ground pin 420 to penetrate shielding cover 300 in a state of non-contact like power supply pin 410.

When configured in this way, ground pin 420 mainly performs a role of removing conducted EMI flowing directly from stator 200 itself into ground pin 420, and ground line 510 mainly performs a role of removing radiated EMI radiated into an inside of housing 100, dividing types of noise mainly removed by ground pin 420 and ground line 510 to reduce a load of each configuration.

Meanwhile, referring to FIG. 1, rotor 600 disposed at an inside of housing 100 comprises rotating shaft 610. Rotating shaft 610 is provided at rotor 600 to penetrate a center of rotor 600 so that rotor 600 can stably rotate in a fixed position.

Impeller 620 can be coupled to first end of rotating shaft 610, and impeller 620 can be provided as a separate part and coupled to rotating shaft 610, or it is also possible to integrally manufacture rotor 600 and impeller 620. Impeller 620 coupled to first end of rotating shaft 610 is synchronized with rotation of rotor 600.

Meanwhile, a structure supporting rotating shaft 610 is formed at an inside of rotor 600 and can support first end of rotating shaft 610, and second end of rotating shaft 610 can be supported by spherical ball 700 provided at an inside of the housing and serving as a bearing. More specifically, recessed groove 170 is formed at an inside of the housing to insert a part of second end of rotating shaft 610, and spherical ball 700 is inserted at an inside of recessed groove 170.

And, a part of second end of rotating shaft 610 is inserted into recessed groove 170 formed at an inside of housing 100 and is supported by spherical ball 700, so that both end parts of rotating shaft 610 are supported. Thereby, a position of rotating shaft 610 can be fixed, so that rotor 600 can stably rotate.

Meanwhile, referring to FIG. 8, according to the fifth embodiment, spherical ball 700 supporting second end of rotating shaft 610 can be replaced. That is, shielding cover 300 can be further extended to form rotating shaft support part 360 to support an end part of second end of rotating shaft 610 inserted into recessed groove 170 at an inside of housing 100.

According to the fifth embodiment, both an electromagnetic wave shielding structure in the motor and a support structure of rotating shaft 610 can be simultaneously formed through shielding cover 300, which is advantageous in cost and time for manufacturing the motor. In addition, ball 700 serving as a bearing can be deleted, so that an effect of simplifying the mold can be expected.

Although shown and described in relation to specific embodiments of the present disclosure, it is obvious to those skilled in the art to which the present disclosure pertains that the present disclosure can be variously improved and changed without departing from the technical idea of the present disclosure provided by the claims below.

What is claimed is:

1. A motor comprising:
a housing made of a polymer material,
a stator provided inside the housing;
a shielding cover inserted at one side of the housing and overmolded, wherein the shielding cover is configured to shield electromagnetic waves; and
a power supply pin and a ground pin, each of which comprises a first end and a second end and penetrates the shielding cover, wherein the first end is connected to the stator, and the second end is exposed to one side of the housing.

2. The motor of claim 1, wherein the stator is overmolded at an inside of the housing.

3. The motor of claim 1, wherein the housing comprises a connector, the power supply pin and the ground pin connected to the stator being exposed to one side of the housing through the connector, and wherein the second end of each of the power supply pin and the ground pin is disposed inside the connector.

4. The motor of claim 3, wherein the power supply pin penetrates the shielding cover without contacting the shielding cover.

5. The motor of claim 3, wherein the shielding cover is of a metal material, and wherein the ground pin is disposed at an inside of the connector by penetrating the shielding cover in a state of contact with the shielding cover.

6. The motor of claim 3, wherein the power supply pin is connected to a winding of the stator and is configured to supply power to the stator, and wherein the ground pin is connected to an outside of the stator and is configured to ground the stator.

7. The motor of claim 6, wherein the shielding cover is of a metal material, and wherein the ground pin penetrates the shielding cover in a state of contact with the shielding cover and is configured to simultaneously ground the stator and the shielding cover.

8. The motor of claim 1, wherein the shielding cover comprises: a stator shielding part configured to shield electromagnetic waves generated from the stator; and
a connector shielding part extended to a side part of the connector and configured to shield electromagnetic waves generated in the connector.

9. The motor of claim 8, wherein the first end of the power supply pin is connected to the stator, and wherein the first end of the ground pin is connected to the connector shielding part.

10. The motor of claim 8, wherein a ground line is connected to an end part of the shielding cover spaced apart from the connector shielding part.

11. The motor of claim 10, wherein the first end of the ground line is connected to an end part of the shielding cover through bolting.

12. The motor of claim 10, wherein the first end of the ground pin is connected to an outside of the stator, and the ground pin penetrates the shielding cover without contacting the shielding cover.

13. The motor of claim 1, further comprising:
a rotor provided with a rotating shaft and provided inside the housing, and
an impeller provided at a first end of the rotating shaft,
wherein a second end of the rotating shaft is supported by a spherical ball provided inside the housing.

14. The motor of claim 1, further comprising a rotor provided with a rotating shaft and provided inside the housing, wherein the shielding cover comprises a rotating shaft support part formed at a central end part of thereof, wherein an impeller is provided at a first end of the rotating shaft, and wherein a second end of the rotating shaft is supported by the rotating shaft support part inside the housing.
